(19) United States
(12) Patent Application Publication
(10) Pub. No.: US 2021/0280193 A1
(43) Pub. Date: Sep. 9, 2021

(54) Electronic Speech to Text Court Reporting System Utilizing Numerous Microphones And Eliminating Bleeding Between the Numerous Microphones

(71) Applicant: Certified Electronic Reporting Transcription Systems, Inc., Aventura, FL (US)

(72) Inventors: Lee Goldstein, Aventura, FL (US); Blair Brekke, Naples, FL (US); Mikal Saltveit, Los Angeles, CA (US)

(21) Appl. No.: 17/195,560

(22) Filed: Mar. 8, 2021

Related U.S. Application Data
(60) Provisional application No. 62/986,717, filed on Mar. 8, 2020.

(51) Int. Cl. G10L 15/26; G10L 15/30; G10L 21/0216; G10L 21/028

(52) U.S. Cl. CPC G10L 15/26; G10L 15/30; G10L 2021/02166; G10L 21/028; G10L 21/0216

(57) ABSTRACT

An electronic system for transcription of audio captured during an event using a plurality of microphones, one for each person possibly speaking during the event. A frequency for each microphone in an environment is determined prior to use. During the event audio is received from each microphone. A signal strength of the audio captured by each microphone is captured and utilized along with the frequency for each microphone to determine which microphone is associated with the person speaking. Record audio from microphone determined to be associated with the person speaking and ignore audio from other microphones. Provide recorded audio to a voice to text engine and receive corresponding text from the voice to text engine and present the text to an operator who can modify in real time or after the event. The corresponding text includes confidence levels association with the translation identifies the person speaking in some fashion.

### BACKGROUND

The court reporting industry generates transcripts for the events (e.g., court proceedings, depositions) that the parties wish to have a record of. A court stenographer uses a court stenographer writing machine in order to capture the words spoken in a deposition or court hearing. The process utilizes the stenographer's mechanical perceptual/sensory motor skills, in that the sounds of the words are first entered through the stenographer's auditory system, and then processed down to the physical movements of the fingers. The sounds are entered into the machine, by typing on the keys in phonetics. The phonetics are transcribed/translated utilizing the stenographer's dictionary, which automatically converts the phonetics into words. Depending on how good the stenographer's perceptual motor skills are, coupled with how complete their dictionary is (built up over the years), will determine what amount and percentage of translates there will be (completion rate), and what the amount and percentage of un-translates there will be, in order to later manually edit/transcribe the un-translates into words.

However, there is a shortage of trained stenographers. Accordingly, digital reporters are being utilized to provide the transcriptions. The digital reporters are simply an audio tape recorder loaded onto a hard drive that is transcribed by an individual listening thereto after the fact. The accuracy of the transcriptions of these digital reporters currently do not compare to the accuracies of the court stenographers.

What is needed is an alternative more accurate method and system for providing transcriptions.

### BRIEF DESCRIPTION OF DRAWINGS

The features and advantages of the various embodiments will become apparent from the following detailed description in which:

FIG. 1 illustrates a high-level system diagram of a voice to text transcription system, according to one embodiment;

FIG. 2 illustrates a high-level diagram showing bleeding issues associated with a system utilizing multiple microphones, according to one embodiment; and

FIGS. 3A-B illustrate audio being captured by different microphones and the system selecting the strongest signal audio for translation and discarding the other audio captured, according to one embodiment.

### DETAILED DESCRIPTION

Speech to text software is becoming more common today. The software may be used, for example, to record notes or schedule items for an individual (e.g., Siri please add call mom Tues at 10 am to my schedule, Siri please add milk to my shopping list) or for dictation for school or work projects. The voice to text translation software may be located on a specific device (e.g., computer, tablet, smart phone) or a device may capture the voice and transmit it to a cloud based voice to text system that performs the translation and sends the text back to the device.

The court reporting industry is on the cusp of transitioning from court reporting stenographers to speech to text software due to the shortage of court stenographers and the accuracy issues associated with digital reporters. A speech to text court reporting system can capture text from, for example, testimony in a deposition and translate it into a text-based deposition transcript. The speech to text court reporting system may include microphones, a computing system including a processor, memory and processable readable instructions and a translation engine. The microphones may capture the speech from associated parties and provide it to the computing system. The computing system may determine which microphone has the strongest signal and thus is the audio that should be translated. The selected audio may be provided to the translation engine to covert the speech to text. The translation engine may be a cloud-based speech to text engine that the computing device communicates with to perform the translation. According to one embodiment, the translation engine may be Google speech to text.

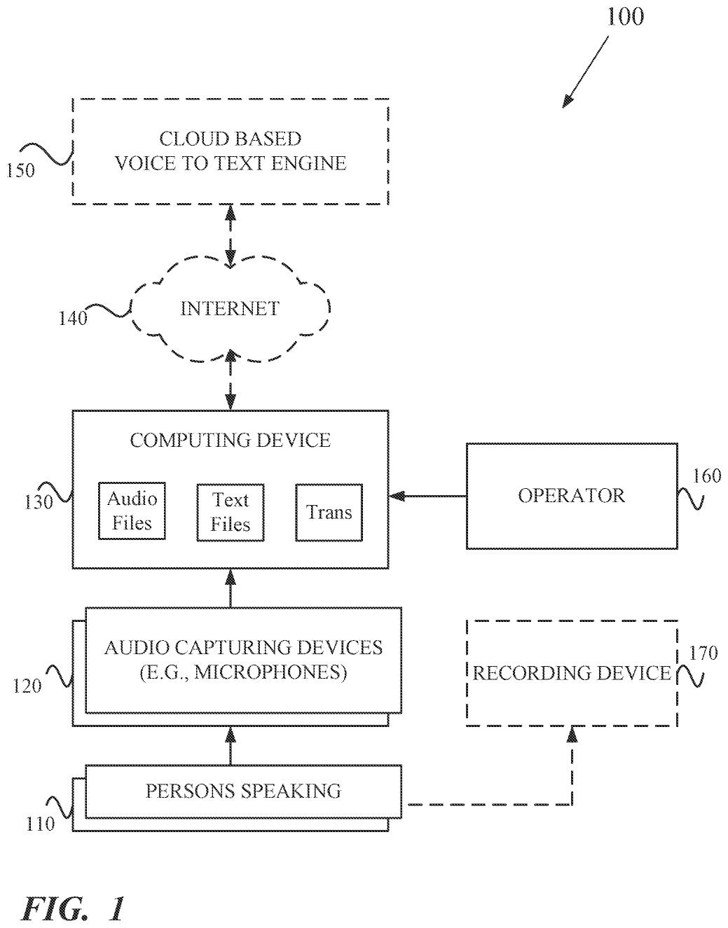

FIG. 1 illustrates a high-level system diagram of a voice to text transcription system 100. The system 100 includes multiple audio capturing devices (e.g., microphones) 120 associated with the multiple persons 110 that may be speaking during the event. Multiple microphones 120 are utilized as a single microphone 120 may not be sufficient to capture the speaking of multiple persons 110, especially if the multiple persons 110 are located remotely from one another. Furthermore, the use of multiple microphones 120 associated with multiple persons 110 enables the audio captured by a microphone 120 to automatically be identified with the associated person 110.

The audio captured by each of the microphones 120 is provided to the computing device 130 as a separate audio channel. A mixer (not illustrated) may be utilized to capture the audio from each of the microphones 120 and provide the audio as a different channel to the computing device 130. The computing device 130 may create an audio file from the captured audio and store the audio file(s). The computing device 130 provides the audio file(s) to a cloud-based voice to text engine 150 via the Internet 140. The audio file may be provided to the cloud-based engine 150 in real time (or close to real time) as the audio file is being captured. The cloud-based engine 150 may convert the audio file to a text file. The text file may be created in close to real time. In addition to the converting the audio to text the cloud-based engine 150 may provide some sort of confidence level as to the accuracy of the translation. The confidence levels may be incorporated into the text file or may be a separate file. The text file and the confidence level (either integrated as one file or as separate files) are provided to the computing system 130 via the Internet 150. The text files may be stored on the computing device.

The text files may be presented on a display of the computing device. The confidence levels for the translation may be illustrated by, for example, utilizing different colors. When the text is presented it may be formatted in a transcription format where the speaker is identified, and the text is identified as question, answer or colloquy. An operator 160 may review the text as it is being presented on the display and make changes thereto as desired or required. The operator 160 may have short cuts identified that can be used in real time to edit the transcription or document notes for later consideration in real time. The edited text file may be a draft transcription that may be stored for later editing and or certification of the transcript.

When reviewing the draft transcript, the operator may want to listen to the audio for certain text captured. The computing system may sync the audio files and the text files so that when the operator selects certain text the associated audio is replayed.

According to one embodiment, the system 100 may include a separate recording device 170 may be utilized that can capture the overall dialogue in the room. This separate recording device 170 may essentially be a digital recorder that is being utilized today to capture audio and have it remotely transcribed. The separate recording device 170 may be for back up purposes.

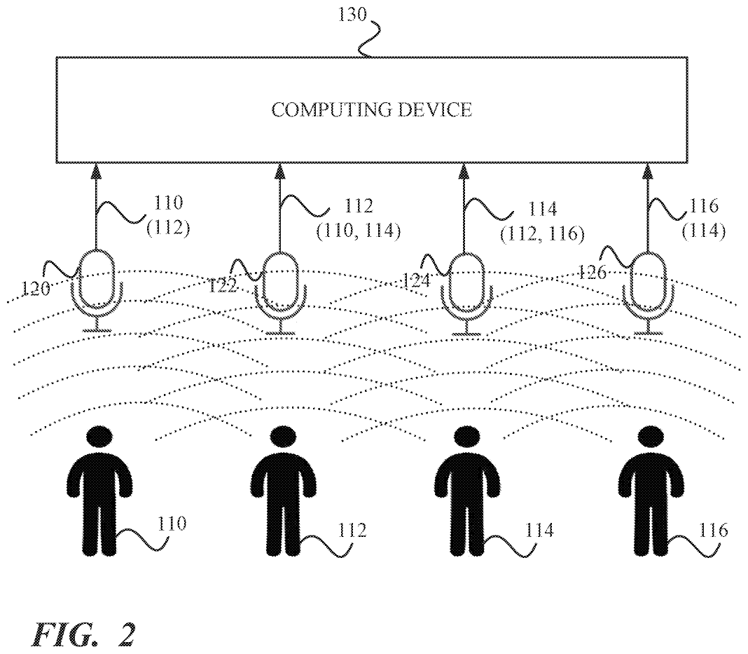

FIG. 2 illustrates a high-level diagram showing bleeding issues associated with a system utilizing multiple microphones. As illustrated, there are four individuals (or groups of individuals) 112, 114, 116, 118 who may be speaking during the event (e.g., deposition). Each person has a microphone 122, 124, 126, 128 associated therewith (placed in close proximity thereto). As can be seen, the voice from individual radiates out therefrom and may be picked up by the associated microphone as well as other microphones associated with other individuals that may be within range. For example, individual 112 may be picked up by associated microphone 122 as well as microphone 124 to the right thereof; individual 114 may be picked up by associated microphone 124 as well as microphone 122, 126 on either side thereof; individual 116 may be picked up by associated microphone 126 as well as microphone 124, 128 on either side thereof; and individual 118 may be picked up by associated microphone 128 as well as microphone 126 to the left thereof.

As such, each microphone may have received speech associated with more than the corresponding individual and may transmit the speech of various individuals to the computing device. For example, microphone 122 may provide voice received from associated individual 112 as well as individual 114 to the right thereof; microphone 124 may provide voice received from associated individual 114 as well as individuals 112, 116 to either side thereof; microphone 126 may provide voice received from associated individual 116 as well as individuals 114, 118 to either side thereof and microphone 128 may provide voice received from associated individual 118 as well as individual 116 to the left thereof.

As one would expect, bleeding between microphones could create a major problem in the translations, as the same speech could be provided from multiple sources. As such, the translations may be duplicative (provide overlapping text). Furthermore, the speech captured may vary between microphones. Accordingly, the duplicative text provided by the voice to text engine may be different based what was captured by each microphone. For example, one microphone may not capture all of the words while the other does. Alternatively, the speech captured by the different microphones may result in different words being transcribed.

What is needed is a manner to avoid the bleeding where only the appropriate microphone provides the speech to the speech to text engine (local or cloud based). One possible solution to bleeding would be to only have one microphone active at a time. This could be accomplished in various manners such as pressing an active button on the microphone or having an operator activate only one microphone at a time. However, this solution is not deemed practical in most applications (e.g., deposition and court settings).

The frequency of each microphone is recorded by the software before the speech to text application begins. Frequency is the number of occurrences of a repeating event per unit of time, which emphasizes the contrast to spatial frequency and angular frequency. Frequency is an important parameter used here to specify the rate of oscillatory and vibratory phenomena, which allows the ability to utilize the specific mechanical vibrations and audio signals (sound) of a particular person.

The frequency of the microphone along with the signal strength of the audio can then be used to determine and identify which microphone is the closest to the person speaking. The audio captured by this microphone will be recorded in the audio file and be transcribed using the voice to text engine. The audio captured by the other microphones (the microphones not associated with the person speaking) will be ignored and possibly discarded.

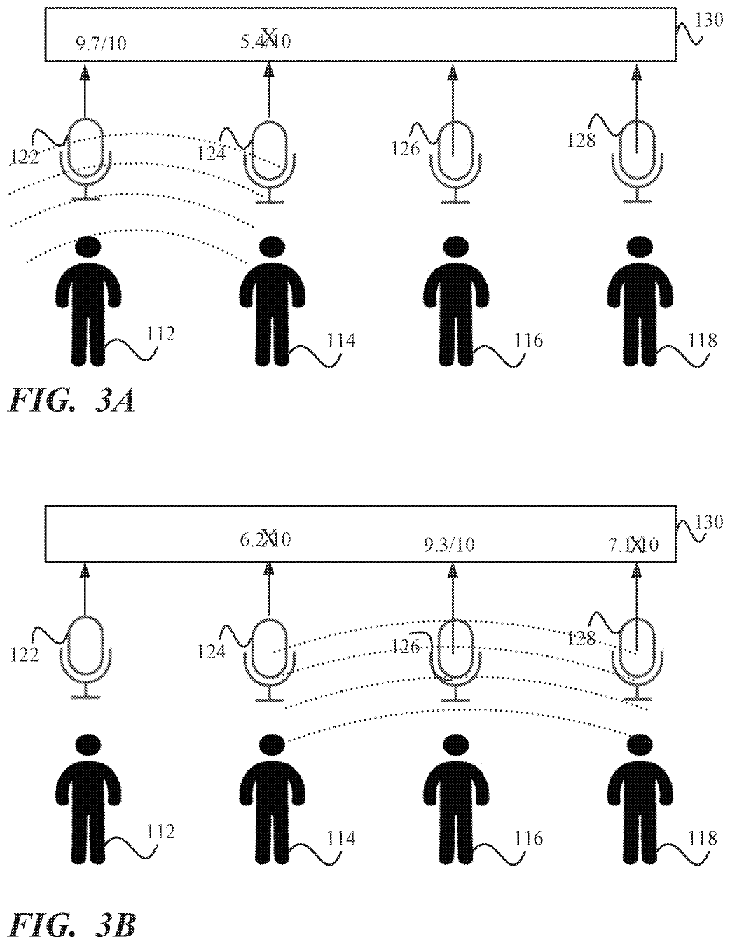

FIGS. 3A-B illustrate audio being captured by different microphones and the system selecting the strongest signal audio for translation and discarding the other audio captured. FIG. 3A illustrates a first time frame in which person 112 is speaking and the audio is captured by microphone 122 as well as microphone 124. The signal strength of the audio from microphone 122 is stronger so it is forwarded for translation while the audio captured by microphone 124 is discarded. It should be noted for ease of understanding the signal strength is illustrated as being scored from 1-10.

FIG. 3B illustrates a second time frame in which person 116 is speaking and the audio is captured by microphone 126 as well as microphones 124, 128. The signal strength of the audio from microphone 126 is stronger so it is forwarded for translation while the audio captured by microphones 124, 128 are discarded.

In addition to programming the frequency for each microphone into the system, other parameters about each microphone may be programmed into the system. For example, the person the microphone is associated with may be programmed into the system. The person may be identified in the system by name, by position (e.g., expert, attorney), by party (e.g., plaintiff, defendant), or by task (person asking questions, or person answering questions). The system may utilize the person associated with the microphone in the transcription. For example, attorney asked “What is your name”, expert answered “Mr. Smith”, Mr. Jones asked “how many years have you worked in this field”, and Ms. Baker answered “25 years”.

An operator 160 of the system may monitor the translations and the event as it is occurring and make any adjustments that are deemed appropriate. For example, if it is determined that the speech was not detected the operator 160 may ask for the person to repeat what they said. In addition, if an objection is made or some other event occurs that would call for an informal off the record conversation, the operator may indicate the conversation is colloquy (which will indent the text in the transcript).

The operator 160 may be able to modify the transcription that is generated in the system. For example, if text shows up that is marked as low confidence the operator may listen to the synced audio and make the necessary corrections. The text file may be exported to a word processing program.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

1. An electronic system for transcription of audio comprising
a plurality of microphones, wherein each microphone is associated with a party; and
a computing device to account for bleeding of audio between the plurality of microphones, wherein the computing device is configured to
record a frequency for each microphone in an environment prior to use;
receive audio from each microphone during use and utilize signal strength of the audio captured by each microphone and frequency for each microphone to determine which microphone is associated with person speaking;
record audio from microphone determined to be associated with the person speaking and ignore audio from other microphones;
provide recorded audio to a voice to text engine;
receive corresponding text from the voice to text engine and present the text to an operator.

2. The system of claim 1, wherein the voice to text engine is a cloud-based engine.

3. The system of claim 2, wherein the computing device transmits the recorded audio to the cloud-based engine via the Internet.

4. The system of claim 1, wherein the operator may monitor the text presented on the computing device during use.

5. The system of claim 4, wherein the operator may edit the text presented.

6. The system of claim 1, wherein the corresponding text includes confidence levels association with a translation of the text.

7. The system of claim 1, wherein the corresponding text identifies the person speaking in some fashion.

8. The system of claim 1, wherein the corresponding text identifies type of speech.

9. The system of claim 8, wherein the type of speech includes question and answer.

10. The system of claim 1, wherein amount statistics regarding the translation are captured.

11. The system of claim 1, further comprising a separate recording device to capture conversations between all parties in the environment.
